(19) United States
(12) Patent Application Publication
(10) Pub. No.: US 2011/0297709 A1
(43) Pub. Date: Dec. 8, 2011

(54) Wetsuit Entry Device and Method for Manufacturing

(76) Inventor: Guy Needham, Oakland, CA (US)

(21) Appl. No.: 13/155,216

(22) Filed: Jul. 14, 2011

Related U.S. Application Data
(60) Provisional application No. 61/352,661, filed on Jun. 8, 2010.

(51) Int. Cl. A47G 25/90; B23P 19/04

(52) U.S. Cl. 223/111; 29/428

(57) ABSTRACT

A device in the form of a slipper which may be worn on foot (primarily) or hand which assists a wearer in entering a wetsuit by reducing friction between the wetsuit material and the wearer's skin. The device has a sole portion and top portion stitched, glued or otherwise sealed at the edges to form a foot or hand pocket. The device is tapered at the toe to prevent snagging during wetsuit entry. The device is open at the heal and contoured around the ankle bone to prevent excess material from hindering wetsuit entry, and to prevent the wearer from grabbing the material through the wetsuit, when commonly gripping the wetsuit on either side of the ankles in order to push the foot through the opening. A preferred embodiment includes both top facing and bottom facing pockets to assist a wearer in grabbing and pulling the device off the foot or hand once the device is through the wetsuit ankle or wrist opening. Once the wearer has inserted his foot through the opening, the slipper provides protection from concrete, sand or dirt, and helps keep the foot conveniently free of dirt and pebbles. The device is easy to carry, easy to store, and reusable. It won't distort its shape even after many uses. It does not absorb water or allow dirt, sand or pebbles to cling to its surface. It can be made in a variety of waterproof, friction reducing and durable materials such as but not limited to nylon, silicone, and tough plastic.

### CROSS-REFERENCE TO RELATED APPLICATIONS

This application claims the benefit of provisional patent application Ser. No. 61352661 filed 8 Jun. 2010 by the present inventor.

### FIELD OF INVENTION

The present invention relates to a removable slipper type device primarily for foot or hand which is used to assist a person in putting on a wetsuit, dry suit or other tight fitting garment and a method for manufacturing the same.

### BACKGROUND OF INVENTION

Cold water sports, such as surfing, diving, water skiing and the like, are enjoyed by millions of people worldwide. Participants living in moderate or cold water climates will most often wear a wetsuit to insulate them from the cold water temperature and to provide a more enjoyable sporting experience. Such wetsuits are typically made of a flexible insulating material, such as neoprene rubber, which allows the wearer to move freely in water.

Wetsuits generally have sealed seams and a single zipper entry system to minimize the amount of water flowing through the suit once the participant is in the water. The legs and arms of the suit are tapered toward the ankle and wrist openings and the suit is worn relatively tight on the body. The wearer will enter the suit from the zippered back portion, typically inserting his feet into the larger end of the tapered leg portion and will push his foot through the tapered leg sleeve and through the ankle opening. Once both legs have been inserted in this way, the wearer will typically push one hand through the tapered arm sleeve and out the wrist opening. He will then insert the other hand through the opposite sleeve and out the opposite wrist opening. Once both arms and legs are in, the wearer will zip up the back. The zipper is usually positioned such that the zipper starts at the small of the back and finishes at the top of the neck opening. Once zipped up, the wearer will generally put on optional booties, gloves and head coverings as needed.

Wetsuits can be very difficult to put on, particularly in dry, cold or sandy conditions. The tapered portions for legs and arms require the wearer to push his feet and hands through stretched suit material and out narrow openings. The friction of the stretched rubber suit passing over the skin can be significant and, depending on the thickness, tightness, flexibility, and age of the suit material, can prevent the wearer from getting feet (and hands) through openings without considerable effort. Sometimes the excess friction of the skin against the suit and stretching of the suit material as a leg or arm is inserted into the legs and arms leads to tearing of the expensive wetsuit fabric and/or suit seams, which then allows water into the wetsuit. The greater the friction, the more difficult it is to put the suit on. Getting sand or dirt between the suit material and the skin only compounds the problem and can make putting on a suit particularly uncomfortable, time-consuming, laborious, and detrimental to the integrity of the wetsuit.

Most wetsuit wearers will delay putting their wetsuits on until they are about to enter the water. While wetsuits are relatively comfortable to wear in cold water, they can be overly restrictive and/or too warm to wear for much time out of the water. That is why one will see most surfers or divers, for example, putting on their suits in a parking lot or beach just prior to their entering the water. This is often not an easy task because the ground in these areas can be exceptionally rough, hot, cold, sandy, or dirty. Wearing thick foot protection, such as shoes, sandals or booties, while putting a wetsuit on is generally impossible because thick protective footwear would prevent the wearer from putting his foot through the ankle opening.

One method for minimizing the effort of putting on a wetsuit is to decrease friction between the wearers skin and the suit material by placing a plastic bag over the wearer's foot, and sliding the foot into the leg and through the ankle opening. While the slick plastic material helps minimize friction, plastic bag rips easily while the foot is pushing through the length of the leg and the opening. Also, a bag is easy to rip while trying to pull it off the foot once the foot is through the opening, which often leaves torn pieces of the plastic bag stuck under the wetsuit above the ankle opening. Repeated use of a plastic bag for this purpose invariably stretches the bag to the point of tearing. A plastic bag is also not thick enough to provide any protection for the foot after it is through the ankle opening and placed on dirt or concrete. Due to its unintended use and loose form, a plastic bag can be too slick and dangerous to stand on. The risk of slipping within the bag while standing on a concrete or even dirt surface can be significant and, for this reason, it may not be worthwhile to use plastic bags for such purpose.

Another method for minimizing friction is putting on a thin nylon sock that is either crew cut or cut so the top of the sock is at the ankle line. Problems associated with this method include that the nylon material is either not slippery enough to substantially reduce friction or it soaks up water which creates more friction. The cut of the sock either at or above the ankle line creates another problem in that it is common for wetsuit wearers to grab the ankle portion of the wetsuit and pull as the foot is exiting the ankle opening. When the wearer grabs the bottom portion of the wetsuit while the ankle portion of the sock is still within the ankle portion of the wetsuit, it is too easy for the wearer to grab both the wetsuit material and the sock material thus impeding the foot from exiting the ankle opening. Wearers who use a sock or use no device to alleviate friction at the ankle and wrist opening of the suit will often pull and grab at the wetsuit material at these locations to extend the size of the opening so the foot or hand will pull through. This creates excess stretching and wear of the wetsuit material at these locations.

Having extra material at the ankle, typical among sock like prior art devices, can also cause bunching of the sock material at the location where the wetsuit leg or arm tapers to the ankle or wrist opening. The bunching creates more friction and impedes progress of the foot or hand through the opening. Further, upon exit of the foot from the ankle opening, the sock material at the ankle remains in the wetsuit requiring the wearer to reach down and pull the sock off the foot and through the ankle opening. In addition to being absorbent to water, sock materials generally pick up dirt, sand and pebbles making them difficult to clean and maintain. Sock material is generally made for comfortable wear as a sock and is necessarily stretchy and therefore susceptible to deformation after a few uses as a wetsuit entry device. Sock like prior art devices are also difficult to store because they absorb water, increase in size and get wet and dirty.

Another method of reducing friction and enabling a speedier entry into a wetsuit is to sew friction reducing material into the wetsuit at the wrist and ankle openings. This method is time consuming and creates excess stitching in the wetsuit. It also sandwiches material between the wetsuit neoprene material and the wearer's skin which can cause excess water to buildup in those locations and lessen the warmth of the suit at those locations. It is also easy for such material to rip at the stitches and/or bunch up at the wrist and ankle location(s) thus hindering the ability of the wearer to move the foot or hand through the opening.

Another method is to use spray silicone or other lubricants on one's foot or hands to minimize friction. Such products are expensive, messy, and need to be repurchased. They also do not keep the foot free of dirt before entering the wetsuit, and do not provide any protection for the foot once it is through the opening. For these reasons, lubricants are not very popular.

Most wetsuit wearers simply ignore all prior art methods of reducing friction because they are either too difficult or create other problems as described above. They will simply struggle to put on their wetsuits while standing on concrete, dirt or sand. Some will bring a mat to stand on which alleviates the footing problem but does nothing to help reduce friction. And mats require storage after use.

### SUMMARY OF INVENTION

The inventor of the device is an avid and experienced surfer who tired of struggling to put on his wetsuit and determined that all prior art methods of alleviating friction were unsatisfactory for the various reasons described above. He determined after many months of thought, trial and error that what is needed is a device that can be put on and taken off easily, which is easy to maintain and store and which can be used for both hand and foot. The size of the device must be big enough to stay on the hand or foot as they are inserted through wetsuit openings but also cut to alleviate bunching and snagging or create the risk of being grabbed by the wearer as the wearer is pulling on the wetsuit to create a bigger opening through the ankle or wrist openings. The device must be relatively inexpensive to make and use, and be easily transferred from one surfer to the next.

The device embodying the principles of the invention described herein is a tailored, soft, slippery, fabric slipper that may be used to assist a wearer in putting on a wetsuit. It is easily placed on the foot (or hand) to allow the wearer to slip his foot (or hand) into tapered legs (or sleeves) and out the ankle (or wrist) openings. With the slipper device on, the foot is protected from dirt that might otherwise be stuck to the wearer's skin and increase friction between suit material and the skin.

The device reduces friction by providing a membrane between the wetsuit material and the wearer's skin. The device is intentionally tapered from its widest point in the direction of the heel in order to hug the ankle and foot slightly, which reduces the likelihood of the device sliding off the foot as the user moves and orients his foot to insert it into the wetsuit leg opening.

The configuration of the slipper device maximizes the reduction of friction at the heal as the wearer pulls the ankle portion of the suit because there is enough material at the tail of the sole to extend beyond the back of the heal to make sure there is material between the wearer's skin and the wetsuit material as the wearer forces the foot through the ankle opening. But the slipper material does not extend from the sole over the ankle of the wearer thus preventing a bunching of excess material at the ankle which could be inadvertently grabbed by the wearer as the wearer pulls on the wetsuit and extends the foot through the ankle opening. Similarly, when the devices is used on a hand instead of a foot, the lack of excess material at the pouch opening makes it less likely for material to bunch and impede progress of the hand through the wrist opening of the wetsuit. Further, the device may be made with strap or pocket which provides a convenient place for the wearer to grab with opposite hand or foot to remove the device without creating any excess material which would impede progress of the appendage through the suit opening.

Once the wearer has inserted his foot through the opening, the slipper provides protection from concrete, sand or dirt, and helps keep the foot conveniently free of dirt and pebbles. This is helpful as the next step in dawning the wetsuit is oftentimes for the wearer to put on neoprene booties to protect the feet from cold water. Wearing the device not only helps eliminate the wearers' annoyance and discomfort in having pebbles in his booties while surfing, but also saves the wearer time getting ready (since he does not have to clean his feet).

The device also eliminates the very common frustration of the wearer's toes snagging on wetsuit seams and folds, which can be painful, frustrating, damaging to both the wearer's skin and to the wetsuit fabric. It also eliminates snags which add time to putting the wetsuit on.

The device can be easily removed by either using a hand to pull on an attached tag or pocket, or by inserting the other foot into the pocket, and pushing, thereby sliding the remaining material through the opening. The device can be made with multiple pockets or tags to allow easy grasping with opposite hand or foot from the top or bottom of the device.

The slipper device is easy to carry, easy to store, and reusable. It can be made in a variety of smooth, water resistant and durable materials such as but not limited to nylon, silicone, tough plastic. The materials are resistant to distortion of its shape, even after many uses. And they won't absorb water or allow dirt sand or pebbles to cling to its surface.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. Once skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth below.

### BRIEF DESCRIPTION OF THE DRAWINGS

In order that the advantages of the invention will be readily understood, a more particular description of various forms of the device embodying the principles of the present invention briefly described above will be rendered in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of a preferred form of a device embodying the principles of the present invention which is shown as it is worn on a wearer's foot.

FIG. 2 is a side perspective view of a preferred form of a device embodying the principles of the present invention depicted in FIG. 1.

FIG. 3 is a preferred blank used for making a preferred form of a device as depicted in FIGS. 1 and 2.

FIG. 4 is an alternative blank used for making a preferred form of a device as depicted in FIGS. 1 and 2.

FIG. 5 is a perspective view of an alternative form of a device embodying the principles of the present invention which is shown as it is worn on a wearer's foot.

FIG. 6 is a side perspective view of the alternative form of a device embodying the principles of the present invention depicted in FIG. 5.

FIG. 7 is a perspective view of an alternative form of a device embodying the principles of the present invention which is shown as it is worn on a wearer's foot FIG. 8 is a side perspective view of an alternative form of a device embodying the principles of the present invention depicted in FIG. 7.

FIG. 9 is a preferred blank used for making an alternative form of a device as depicted in FIGS. 7 and 8.

FIG. 10 is an alternative blank used for making an alternative form of a device as depicted in FIGS. 7 and 8.

FIG. 11 is a perspective view of an alternative form of a device embodying the principles of the present invention which is shown as it is worn on a wearer's foot.

FIG. 12 is a side perspective view of an alternative form of a device embodying the principles of the present invention depicted in FIG. 11.

FIG. 13 is a preferred blank used for making an alternative form of a device as depicted in FIGS. 11 and 12.

FIG. 14 is an alternative blank used for making an alternative form of a device as depicted in FIGS. 12 and 13.

FIG. 15 is a perspective view of a wearer grasping the top pocket portion of the preferred embodiment of the device as the wearer's foot is being pushed through the ankle opening of a wetsuit.

FIG. 16 is a perspective view of a wearer grasping the wetsuit material at the ankle portion of a wetsuit as the wearer pushes the foot through the ankle opening of the wetsuit.

### DETAILED DESCRIPTION

Reference will now be made in detail to various embodiments in accordance with the principles of invention, examples of which are illustrated in accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details as previously stated. Further, the invention should not be construed as limited to being worn on a foot or hand. The invention may be applied to being worn on almost any part of the body that is to be inserted into a wetsuit and pulled through an opening. Although most of the embodiments depicted in the figures will be described with reference to the embodiment being worn on a foot, the descriptions can be understood to be relevant to use on a hand. In limited cases where the wearer is missing foot or hand, the invention could apply to some other portion of the wearer's arm or leg. For example, use of such words as “sole” or “toe” with regard to various portions of the device should not be interpreted as limiting the device to being worn on the foot only.

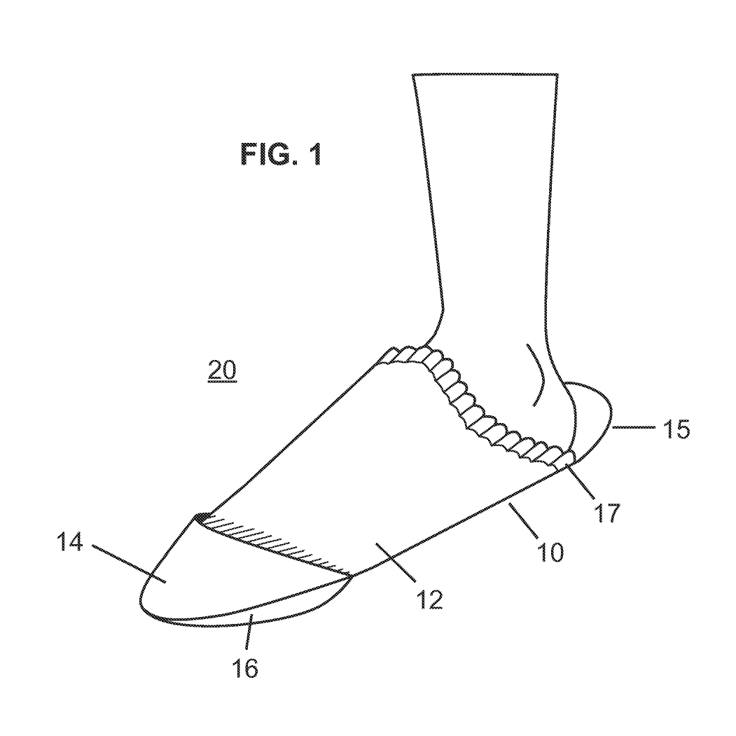

A perspective view of a preferred form of a device embodying the principles of the present invention as it is worn on a wearer's foot is presented in FIG. 1. This form of the inventive device 20 has a sole portion 10 having tail 15 which extends beyond the heal of the wearer, an upper portion 12 sealed to the edges of the sole portion along the sides and toe areas to form a foot pocket, an attached top facing outer pocket portion 14 and an attached bottom facing outer pocket portion 16. The foot opening between the unsealed portions of the upper portion 12 and sole portion 10 allows the user to easily insert his or her foot into the foot pocket. Around the open edge of the upper portion 12 a sewn or overlapping elastic stitching 17 serving to assist in holding the open edge of the upper portion 12 of the device to the wearer's foot but not so tightly as to hinder removal of the device from the wearer's foot following insertion of the foot through the wetsuit ankle opening. Instead of stitching, other means could be used to maintain better fit of the foot pocket such as a rubber band or hook and loop type fasteners, snaps or other easily affixed and removed tightening devices. Elastic stitching is provided in the drawing because such stitching is easiest and least expensive to apply and doesn't provide so much tension as to be difficult to remove. Such stitching does not need to be limited to the open edge of the upper portion. Alternatively, the entire upper portion 12 could include elastic stitching to make the device more snug on the wearer's foot, but is not necessary in most instances and is more expensive to manufacture.

The open heal portion of the sole 10 defines the tail 15 which covers and extends beyond the sole of the foot. Upon insertion of the wearer's foot through the ankle opening of a wetsuit, the tail covers the wearer's heal to reduce friction as the wearer's foot pushes through the ankle opening of the wetsuit but does not provide so much material as to create bunching of the material or to hinder easy removal from the suit. In alternative embodiments, the tail might wrap the sides and back of the wearer's heal. While such wrapping of the heal might assist in helping the device stays on the wearer's foot as the foot is pushed through the wetsuit, a tight wrap of the heal or elastic at the heal could make it more difficult to remove the device from the foot once the foot is through the ankle opening. This is why the preferred embodiment depicts an open healed form.

The material used to make the device 20 is preferably smooth, or alternately has a grain which runs in the direction of the toe making it easy to move the device through the wetsuit in the direction of the toe. The device 20 is preferably made of a thin, strong water resistant fabric (such as nylon, polyester, silicone treated nylon or other strong thin, light and relatively water resistant material used to make parachutes, sleeping bags, and backpacks). An example of a very specific type of suitable material would be the material called “Spectra” which is an ultra-high molecular weight polyethylene fiber made by the Honeywell company with a very high strength-to-weight ratio. Such materials are highly resistant to abrasion and are water resistant. Further such material is resistant to UV light similar to polyester. A variety of less expensive materials with similar characteristics could be used such as plastic or even rubberized or silicone treated cotton canvas.

The material used to make the slipper device may be finished with thread stitching (or other permanent bonding methods) at the seams in order to maintain the structural integrity and strength during use when pressure is exerted on the fabric and seams by the user when inserting or extracting a foot or hand from a wetsuit. The conical shape of the toe portion of the foot pocket effectively pushes the toes of the user together into a more streamlined shape to facilitate the user pushing the foot through the leg of the wetsuit, and also diminishes the chances that the user's toes will snag on seams or folds of the wetsuit as the foot (or hand) slides through.

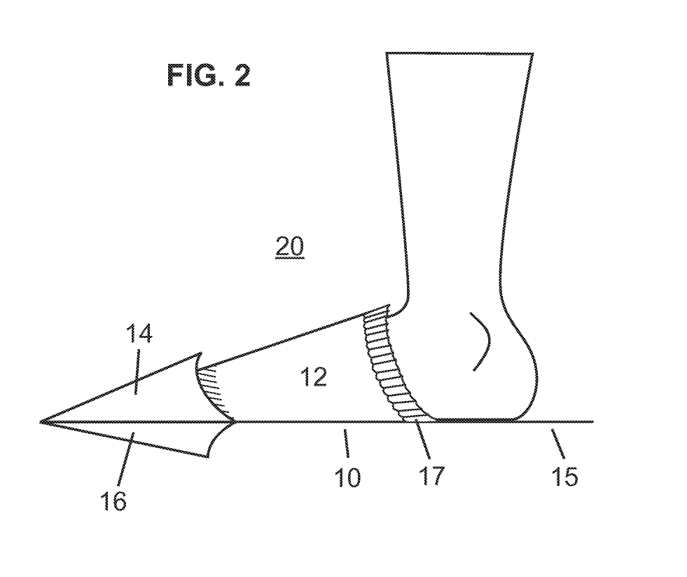

FIG. 2 shows how the top facing outer pocket 14 and bottom facing outer pocket 16 of the preferred embodiment are easily available to the wearer in pulling the device off the foot or hand once the wearer has pushed his/her hand through the ankle or wrist openings of the wetsuit. Alternatively, a tab affixed to the toe portion of the device could provide an adequate, though less accessible, grasping option.

In FIG. 2, there is purposefully no fabric on the device that covers either the left or right sides of the ankle of the wearer, due to the common practice among users of grabbing the exterior of the wetsuit on either side of the ankle as the foot (with the device on it) is pushed through the ankle opening. The lack of slipper material in this area diminishes the possibility that the user will inadvertently grab and hold the device under the wetsuit while attempting to push the foot through the ankle opening. Once the slipper device is mostly through the opening, the wearer may hook his fingers into the top-facing pocket 14 (or alternative bottom-facing pocket 16) to easily pull and extract the foot or hand through the wetsuit opening. Alternately the wearer, who in common practice may be sitting down, can also insert the toes of his free foot into either pocket, and thereby push the slipper device off his foot, rather than bend down to use his hand to pull it off. The restrictive nature of wetsuit material (particularly when wet) can often make it difficult for some wearer's to actually reach down and pull the device off with the hand. Thus, the outer pocket or pocket makes it easy for the wearer to use a foot instead of a hand to pull the device off a foot once the foot is through the ankle opening.

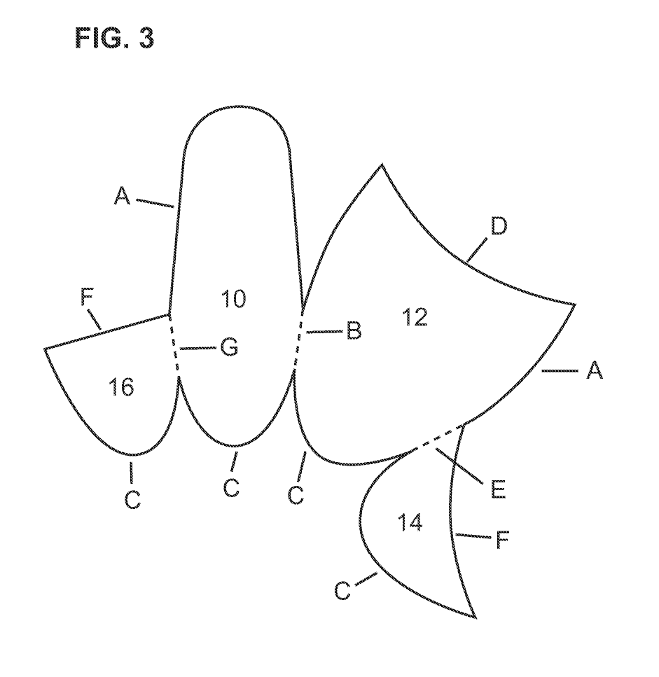

FIG. 3 shows a blank that may be used for making the preferred form of the invention as shown in FIG. 1. The figure illustrates a single-piece blank that is folded and stitched (or glued) along certain edges to easily define the invention. The piece folds at dotted lines along longitudinal line B to define a sole portion 10 and an upper portion 12. Longitudinal edges A are sealed to one another (i.e. stitched or glued) to seal the side. Curved edges C are sealed to one another (i.e. stitched or glued) to form the toe portion of the foot pocket. Such sealed toe portion of the foot pocket is rounded and forms what could be referred to as a toe box. But, edge D is not sealed so that there is an opening to allow the foot or hand to be inserted in the device. The top facing outer pocket portion 14 is then formed by folding the material in the opposite way over the upper portion 12 at dotted lines E. The pocket portion 14 is then sealed along edges C to form the upper-facing pocket, but not along curved edge F to allow an opening for a hand to easily grab hold, or for the other foot to slide in and push/pull it off. Similarly, the bottom facing outer pocket 16 is formed by folding the material under the sole 10 and sealing it along the curved edges C. The F edges of pockets 14 and 16 are different in the preferred embodiment. The top facing outer pocket 14 has a curved edge F to accommodate the bulge formed by the foot being inserted into the foot pocket and maintain enough opening to allow a hand or foot to be easily inserted in the pocket 14. The bottom facing outer pocket edge F is straight because it is positioned under the sole 10 of the device where there is not as much of a bulge from the foot and the straight edge F forms a pocket edge which is easier to grasp. However, in alternative forms, the F edges of the outer pockets may be curved or straight. The basic method of manufacture includes cutting a blank in the shape described in the figure, folding and sealing the edges as described. Other elements, such as elastic stitching at the foot pocket upper portion 12 open edge (see item 17 on FIG. 1) may then be applied as desired for the particular embodiment.

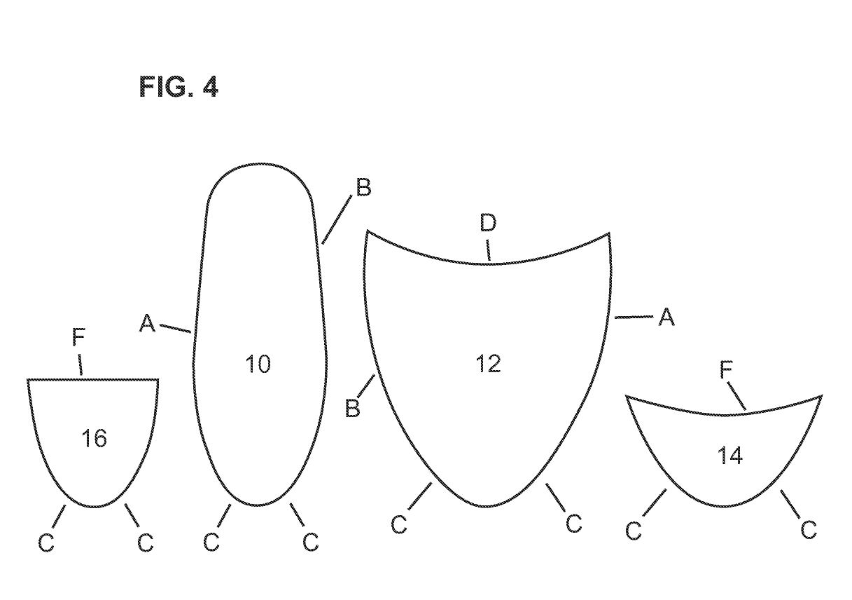

FIG. 4 is an alternative blank used for making the preferred form of the invention as shown in FIG. 1. This time, the blank is presented in 4 separate pieces; the sole portion 10, the upper portion 12 and the top-facing outer pocket portion 14, and the bottom-facing outer pocket portion 16. Edges A, B and C of the upper portion 12 are sealed (i.e. stitched or glued) to corresponding edges A, B, and C of the sole portion 10 to form the sides and the toe box of the slipper. Curved edge D of the upper portion 12 is left unsealed to form an opening for a foot or hand. The top-facing pocket portion 14 is sealed, stitched or glued at curved edges C to the sealed edge C of the device thus forming a top-facing pocket. The bottom-facing pocket portion 16 is sealed, stitched or glued at curved edges C to the sealed edge C thus forming the bottom-facing pocket. Again, curved edges F of the top and bottom-facing pocket portions are left open to allow the user to easily grab and remove the device with hand or foot. The basic method of manufacture includes cutting the portion of the embodiment as separate pieces of material (see items 10, 12, 14, 16 for this particular embodiment) position one over the other and align so they may be sealed, stitched or glued at the seams either together or in application one at a time. Alternatively, they are sealed, stitched or glued together, separately or in a sequence, whichever is most advantageous depending on what machine or process is used to perform the sealing stitching or gluing. Other elements, such as elastic stitching (see item 17 on FIG. 1) may then be applied for the particular embodiment.

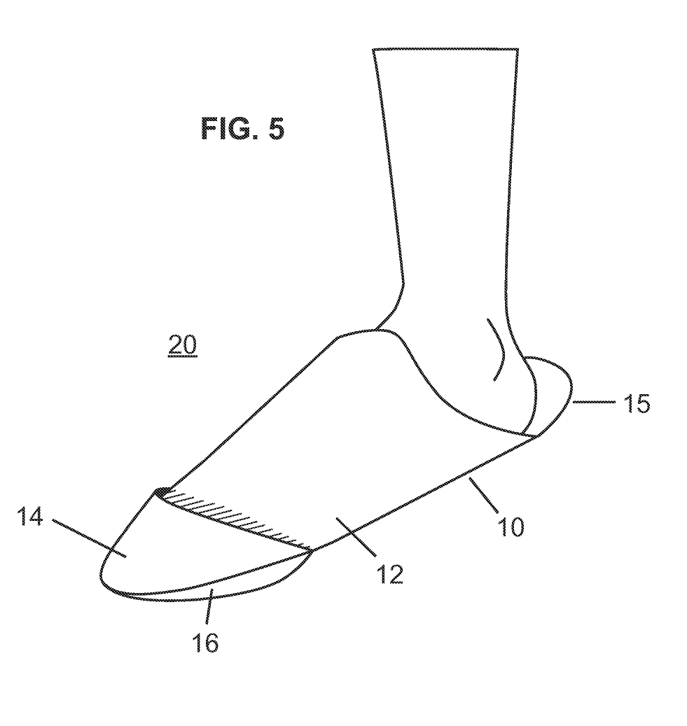

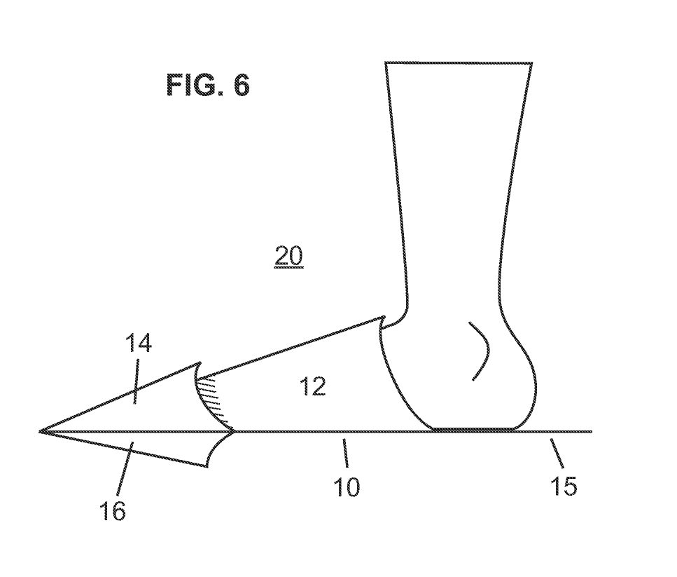

FIG. 5 is a perspective view of an alternative form of a device embodying the principles of the present invention shown as it is being worn on a foot. In this embodiment, there is no elastic stitching 17 at the edge of the foot opening of the upper portion 12 though one or more means for increasing the fit at the pocket opening may be utilized. The upper portion may be contoured such that the toe area of the foot pocket is snug and the device stays on a foot (or hand) without the snugness provided by elastic or other tightening means. FIG. 6 shows a side perspective the same alternative embodiment. One will note that each of the side perspective figures appear to show a sharp pointed toe. This is simply to show how the material may be cut and is not intended to depict how the device will fit when applied to the foot. In reality, the material around the toe seam will sag to fashion a more rounded toe. Similarly, the top and bottom facing pockets may not lie as open as depicted in the Figures. Again, the Figures are provided to show the general outline of each portion of the device as clearly as possible for purposes of labeling and identification. The material is pliable and will likely not form the sharp edges as shown and instead will contour to the foot or hand of the wearer.

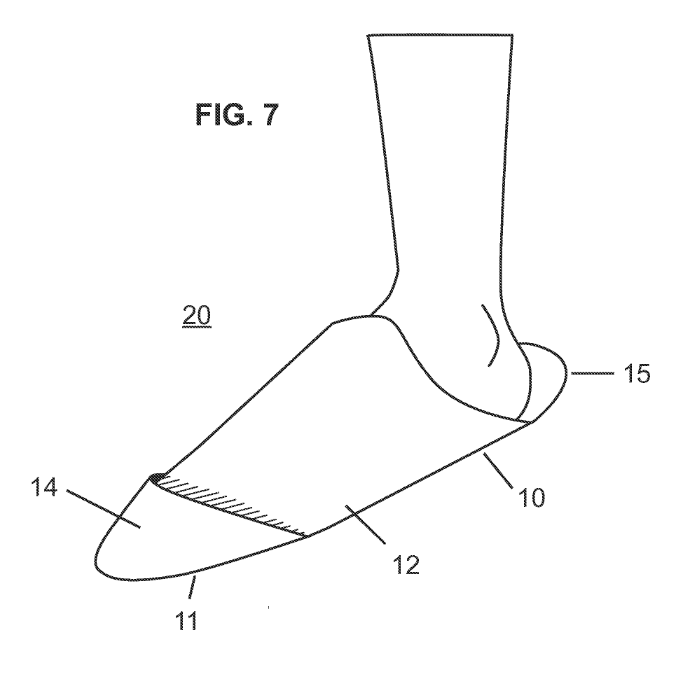

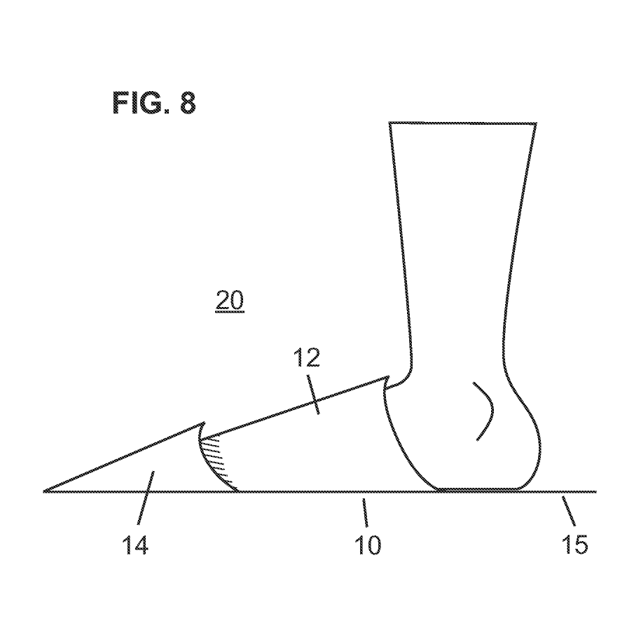

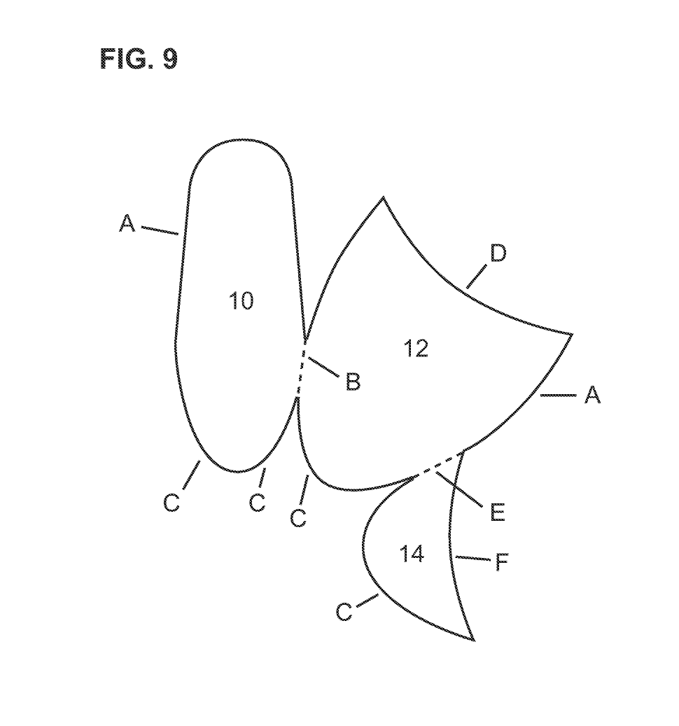

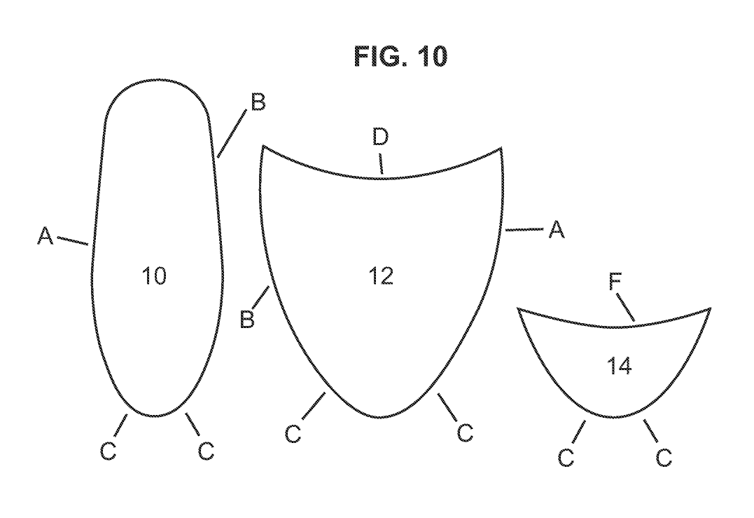

FIG. 7 is a perspective view of an alternative form of a device embodying the principles of the present invention shown as it is being worn on a foot. In this embodiment, there is no bottom facing outer pocket 16 as shown in the figures described above. While this figure shows no elastic stitching as provided in the preferred form shown in FIGS. 1 and 2, such stitching may be provided at the opening edge of the upper portion 12. Alternatively, elastic stitching (see item 17 of FIG. 1) may be provided at other areas of the upper portion 12 to provide a more snug fit around the foot or hand of the wearer. FIG. 9 is a blank which may be used to manufacture the form of the device as shown in FIGS. 7 and 8. This blank is cut in a single piece which is folded at creases B and E and stitched or glued along exterior edges as previously described above with regard to FIG. 3 except that this embodiment does not have a bottom-facing outer pocket 16. FIG. 10 is an alternative blank used for to manufacture the form depicted in FIGS. 7 and 8. The method of manufacture is similar to that already described with regard to FIGS. 3 and 4 above except using the alternative blank(s).

With regard to the method of manufacture of certain embodiments of the inventive device as described above, one should note that the various blanks for each embodiment may be single piece or multi-piece. And each piece may have one or more portions. For example, the single piece blank depicted in FIG. 3 may be used for the manufacture of the embodiment depicted in FIGS. 1 and 2. This single piece blank consist of various portions including upper portion 12, bottom sole portion, top facing outer pocket portion 14 as well as bottom facing outer pocket portion 16. These portions are folded over one another at appropriate seams as depicted and described, the edges aligned to allow it to be appropriately sealing (i.e. stitched or glued) and other features such as elastic stitching 17 may be applied prior to or subsequent to the stitching together of the portions. In contrast, FIG. 4 is an example of a multi-piece blank where each piece is a separate portion (i.e. upper portion 12, bottom sole portion 10, top facing outer pocket 14 and bottom facing outer pocket 16). The each piece is aligned with one another and sealed as described and additional features such as elastic stitching 17 may be provide before or after the pieces are sealed to one another at the appropriate edges. However, one should note that a combination approach is also part of the inventive method. For example a single piece blank having upper portion 12 and top facing pocket portion 14 may be combined with another single piece blank having bottom sole portion 10 and bottom facing outer pocket 16 to form the embodiment depicted in FIGS. 1 and 2. Alternatively, a a multi-piece blank having separate pieces for portions 14 and 16 but a single piece having portions 10 and 12 may be combined to form the same embodiment. As long as the various portions are appropriately aligned and sealed together at the appropriate seams, the blanks can have a variety of single and multi-piece portions combined to form a single embodiment.

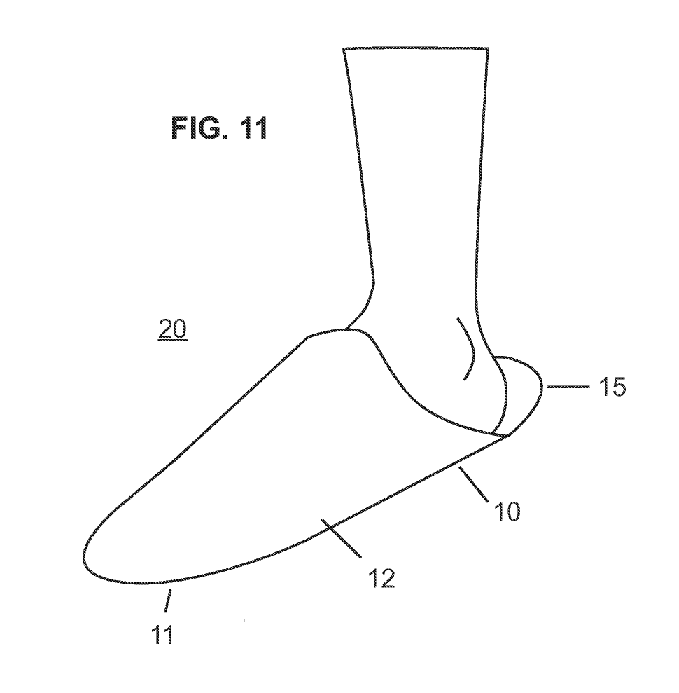

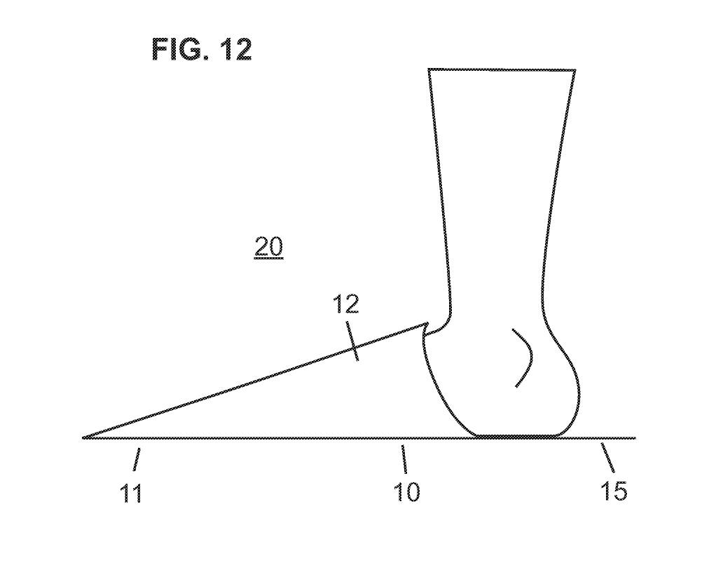

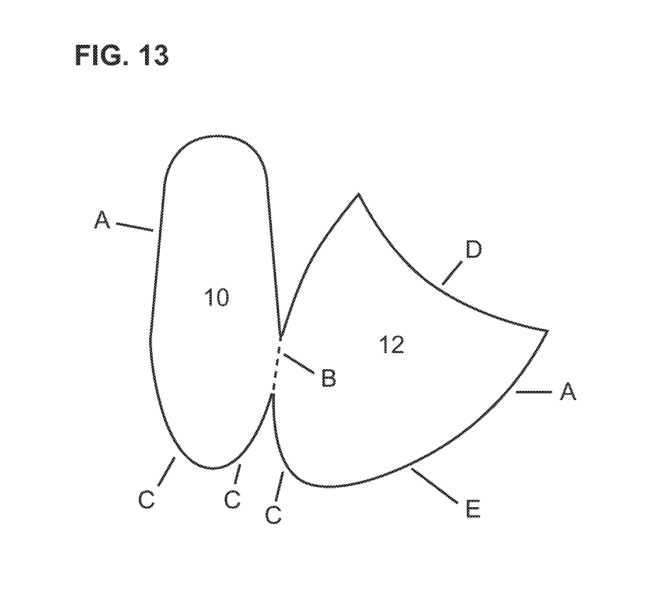

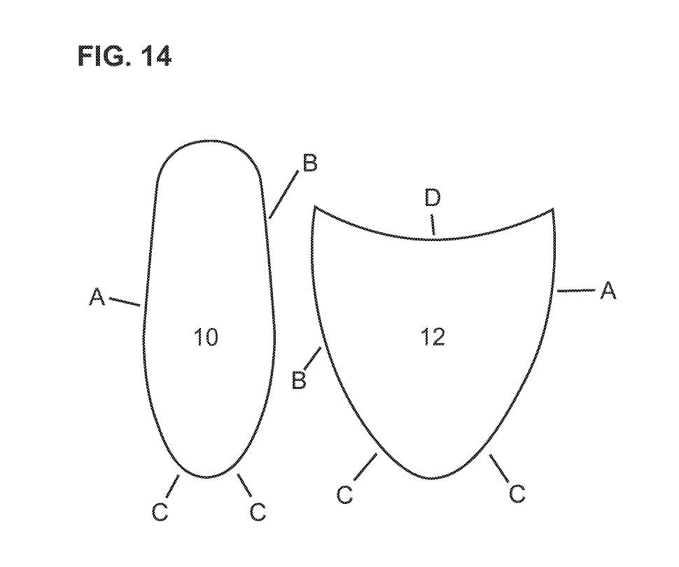

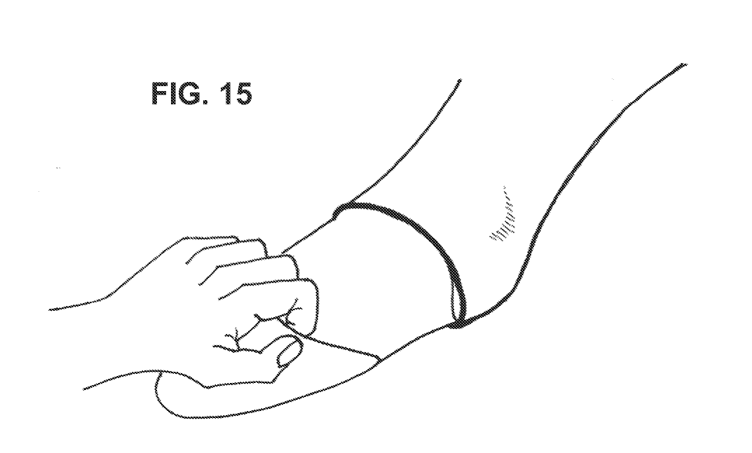

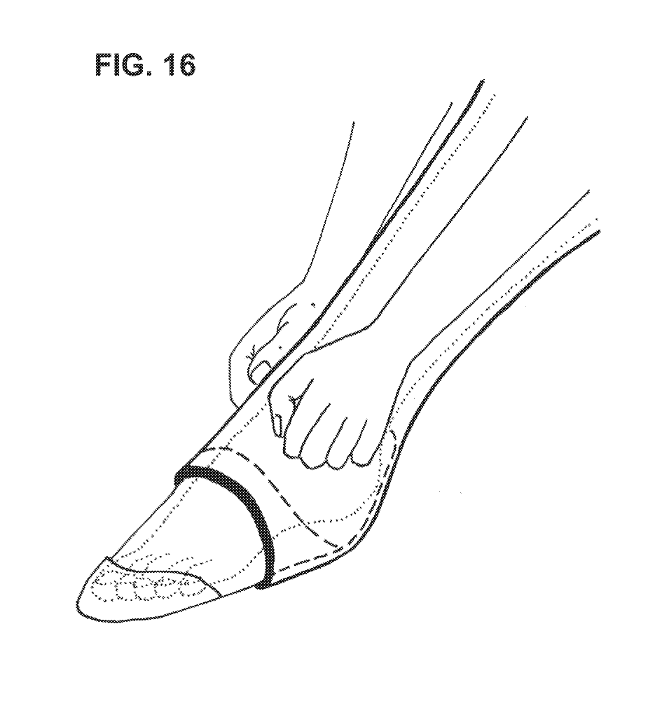

FIG. 11 is a perspective view of an alternative form of a device embodying the principles of the present invention shown as it is being worn on a foot. In this embodiment, there are no top or bottom facing outer pockets. However, the device may be made with a tag or other pull tab which may be affixed to the outside of the upper 12 or sole 10 portion of the device to assist in pulling the device from the wearer's foot (or hand) once the foot (or hand) is through the wetsuit opening. Also, elastic stitching may be provided (as shown with regard to FIGS. 1 and 2) to assist in making the device snug on the wearers foot (or hand). The alternative form shown in FIG. 11 is the most basic form, but maintains the cut of the upper portion at the opening to prevent excess material from being grabbed by the wearer should the wearer pull on the wetsuit material at the ankle (or wrist) areas to create a larger opening at the ankle (or wrist) when pushing the foot (or hand) through the opening. FIG. 12 shows a side perspective view of the alternative form of the device as depicted in FIG. 11. FIGS. 13 and 14 show alternative blanks that may be used to manufacture the form as depicted in FIGS. 11 and 12. The method of folding, aligning and sealing (i.e. stitching or gluing) material and seams is similar to that as described for FIGS. 3 and 4 except that there are no outer top and bottom facing pockets or upper portion elastic stitching as described for the preferred embodiment. Still, this alternative form of the slipper device provides the necessary functions to allow easy entry into the wetsuit while mitigating bunching and snagging. And the method of manufacture is similar to that already described with regard to FIGS. 3 and 4 except with these alternative blanks.

As previously described above, the device may be made out of any number of materials, including, but not limited to, heavy-gauge plastic, canvas, nylon, polyester (which tends to be very resilient, quick drying, resistant to biological damage such as mold and mildew, easy to wash, and able to hold forms well), or any other durable and smooth material. This includes fabrics that might have a smooth grain, wherein the material would be oriented at time of manufacture so that the smooth grain runs parallel to the direction of insertion of the foot (hand) through the wetsuit opening for maximum friction reduction.

It will be appreciated that the device embodying the principles of the invention as described herein also provides additional benefits to the user which may not specifically pertain to entry into a wetsuit. The device embodiments described above also provide users (particularly surfers) with a convenient container in which to store small items, such as bars of wax, for which they often have no other handy storage place. The device protects the items (such as sunglasses) from dirt and sand while being stored. Should the wearer choose to carry the device into the water, the device can be easily rolled and stored in a wetsuit pocket (such as a zippered side pocket). This is particular helpful when the wearer needs to walk a good distance from a car or camp to the place where she will put on the wetsuit at the water's edge. As many experienced surfers know, the water break is often located a long distance from a safe place for gear to be stowed. Having the option to carry the suit and put it on at water's edge is preferable in many instances to walking long distances in a heavy and uncomfortable wetsuit. Having a device to help entry into the wetsuit without creating a storage problem can be very desirable in typical circumstances.

The foregoing descriptions of various specific embodiments in accordance with the invention have been presented for purposes of illustration and description. They are not intended to be exhaustive or to limit the invention to the precise forms disclosed, and obviously many modifications and variations are possible in light of the above teaching. The invention can be construed according to the appended claims and their equivalents.

It will thus be appreciated by those skilled in the art that one will be able to devise numerous alternative arrangements that, while not shown or described herein, embody the principles of the invention and thus are within its spirit and scope.

1. A slipper apparatus to aid in the easy entry of a tight fitting garment comprising:
an upper portion extending over a wearer's toes and top of the foot but terminating just below the ankle;
a sole portion extending from the wearer's toes and under the sole of the foot terminating beyond the wearer's heal;
wherein said upper portion is aligned with and sealed to said sole portion at the exterior edges to form an open foot pouch with tail.

2. An apparatus as in claim 1 wherein said upper and sole portions are made of lightweight, durable, and slippery material.

3. An apparatus as in claim 1 wherein said upper and sole portions are tapered to fit the foot.

4. An apparatus as in claim 1 wherein said sole portion terminates at approximately 1 inch beyond the back of the wearer's heel.

5. An apparatus as in claim 1 wherein said upper portion includes one or more upper facing pockets to allow easy removal with hand or foot.

6. An apparatus as in claim 1 wherein said sole portion includes one or more bottom facing pockets to allow easy removal with hand or foot.

7. An apparatus as in claim 1 wherein said sole portion is padded.

8. An apparatus as in claim 1 wherein the perimeter edges of the upper portion, sole portion and pockets are contoured to fit the wearer's foot.

9. A method for making an apparatus for easy entry into a tight fitting garment comprising:
cutting an upper portion panel, sole portion panel, and at least one pocket panel from lightweight, durable and slippery material,
placing said upper portion panel over said sole portion panel and aligning toe and sides,
placing a pocket portion on top of said upper or under said sole portion and aligning the perimeter edges, and
affixing said upper, sole and pocket portions at the perimeter edges leaving an open foot pocket and open upper or bottom facing pocket.

10. A method for making an apparatus for easy wetsuit entry comprising as in claim 9 except that a single piece blank having upper portion, sole portion and at least one pocket portion is used.
